(19) United States
(12) Patent Application Publication
(10) Pub. No.: US 2009/0292576 A1
(43) Pub. Date: Nov. 26, 2009

(54) METHOD FOR EVALUATING SPECIFIC DATA IN RELATION TO CLEANING UP/DISMANTLING A FACILITY

(75) Inventors: Guy DECOBERT, Orsay (FR); Stephane Robic, Villeneuve-Les-Avignon (FR); Marie-Claude Billard, Paris (FR)

Correspondence Address: Nixon Peabody LLP, 200 Page Mill Road, Palo Alto, CA, 94306, US

(73) Assignees: AREVA NC, Paris (FR); COMMISSARIAT A L'ENERGIE ATOMIQUE, PARIS (FR)

(21) Appl. No.: 12/467,174

(22) Filed: May 15, 2009

(30) Foreign Application Priority Data
May 20, 2008 (FR) 08 53263

(51) Int. Cl. G06Q 10/00; G06Q 50/00

(52) U.S. Cl. 705/8

(57) ABSTRACT

A method for evaluating specific data in relation to the cleaning up/dismantling of a facility comprising at least one room. This method includes the following steps:

an inventory of the facility is drawn up room by room, assimilating each room with a standard cell which brings into play at least one task to obtain first data,

a set of tasks is associated with a standard scenario,

each task is associated with at least one ratio in order to modify the first data so as to obtain second data,

specific data is determined by evaluating this second data taking into consideration services provided in relation to manpower and general elements.

### CROSS REFERENCE TO RELATED APPLICATIONS or PRIORITY CLAIM

This application claims priority of French Patent Application No. 08 53263, filed May 20, 2008.

### TECHNICAL FIELD

The invention relates to a method for evaluating specific data in relation to cleaning up/dismantling a facility, and for example a nuclear facility.

Hereinafter, in order to simplify the description, a nuclear facility is taken as a non-restrictive example.

### PRIOR ART

The field of the invention is that of the dismantling of facilities, and for example nuclear facilities, which means not only decommissioning the operation, cleaning up, dismantling the equipment and the structures, but also destroying the buildings and removing the radioactive waste, the technical problem so defined being described, for example, in the document listed as [1] at the end of the specification.

The fuel cycle is thus dismantled from a facility in four main stages:
the process equipment is cleaned up; a stage which mainly consists in washing the equipment or removing dust from it in order to dismantle in a way that generates less waste that cannot be stored at a surface storage site, and requires fewer tele-operated operations,
the equipment and structures are stripped out,
the civil engineering structure is cleaned up,
the civil engineering structure is demolished depending on the destiny of the site.

The object of the inventive method is to resolve a technical problem of this kind, by proposing a technical and economic evaluation of said clean up/dismantling operation, said evaluation being conducted in respect of each of the main items: manpower, discharges, waste, supports, engineering, etc.

### DISCLOSURE OF THE INVENTION

The invention relates to a method for dismantling a nuclear facility comprising at least one room, itself comprising equipment and structures, said method including a plurality of dismantling steps and a step of evaluating technical clean-up/dismantling data, characterized in that this evaluation step employs:
a first table listing clean-up/dismantling tasks,
a second table in which each standard cell of a set of standard cells, bringing into play at least one task from the first table, is assigned to a given room in the facility to be cleaned up/dismantled,
a database containing ratios corresponding to the tasks, and in that this evaluation step includes a step of multiplying the ratios corresponding to the tasks in the standard cell assigned to each room in the facility by first data, which are dimensional data, quantitative data or states of contamination of the equipment and structures in this room, so as to obtain second technical data selected from among: time taken in hours, quantities of discharges/waste and doses.

To advantage the ratios are categorized in three classes:
primary ratios independent of the agreed standard scenario (or standard cell) and of the facility under consideration,
scenario ratios dependent on the agreed standard scenarios,
ratios dependent on the facility under consideration.

The inventive method is therefore based on three main elements:
a physical and radiation inventory of the facility,
a database of technical and economic ratios,
a methodological approach via standard scenarios or cells enabling modeling that is appropriate to the entire facility.

### BRIEF DESCRIPTION OF THE DRAWINGS

FIG. 1 shows the steps in the inventive method diagrammatically.

FIG. 2 shows diagrammatically the rooms in a facility to be dismantled with a choice of standard scenarios.

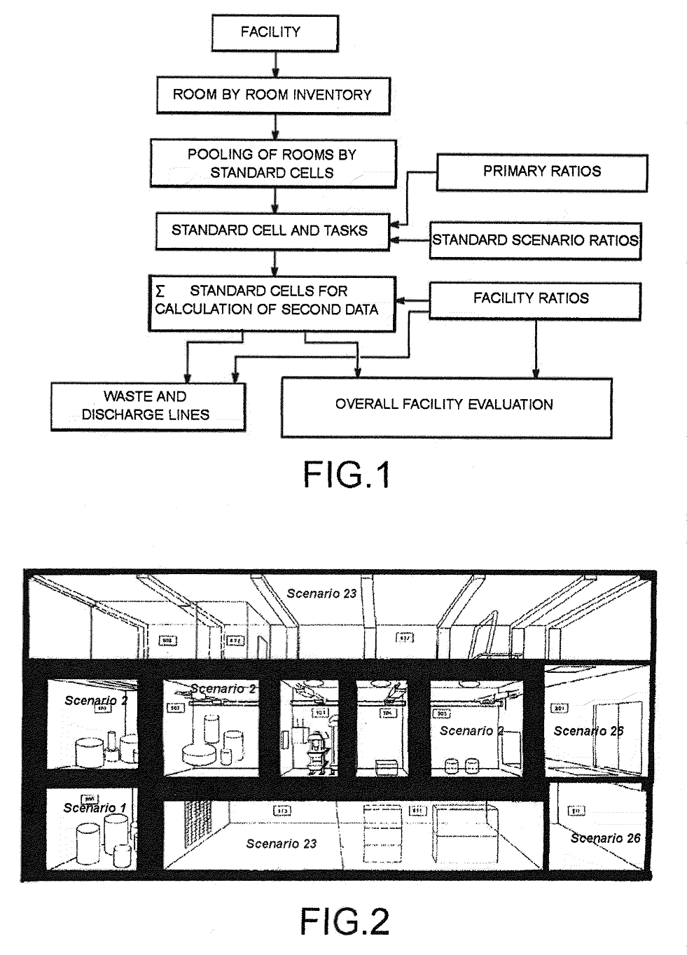

### DETAILED DISCLOSURE OF PARTICULAR EMBODIMENTS

The inventive method for evaluating specific data in relation to cleaning up/dismantling at least one facility, for example a nuclear facility, comprising at least one room, includes the following steps:
a first step of drawing up an inventory of the facility room by room, assimilating each room with a standard scenario, or standard cell, selected from a set of standard scenarios listed in Table I at the end of the specification, which brings into play at least one clean-up or dismantling task among the tasks listed in Table II at the end of the specification, in order to obtain a set of first data,
a second step of associating these tasks with ratios which, when multiplied by the first data produced by the inventory, allow a second set of data to be obtained,
a third step of determining specific data by evaluating this second data taking into consideration services provided in relation to manpower and general elements.

The methodological approach, in the first step, allows the use of a plurality of standard scenarios: high dose rate, medium dose rate, low dose rate cells, containment pools, glove boxes, shielded enclosures, internal and external raceways, chimney stacks, zone 3 rooms, etc.

A standard scenario is assigned to a given room by selecting the most appropriate scenario among those described in Table I, in consideration of the radiological characteristics of the room.

Thus for a type 1 scenario, we have for example:
first data (inventory): these are m, m², m³, t, of the % of very low level radioactive waste categories B, A, etc.
second data (primary quantities): these are hours, tonnes of waste, m³ of discharges, dosimetry.
specific data: evaluation of the second data.

Corresponding tasks and clothing characterize each scenario.

In the first step, the inventory of the facility is taken by collecting, room by room, the following first data:
dimensional data,
quantitative data on plant: amounts of equipment, pipes and fittings, shielding, number and volume of vessels, etc.
state of contamination for the purpose of specifying the standard clean-up/dismantling scenario and the distribution by treatment line and packaging of the discharged waste depending on the nature and radiation activity thereof.

The inventory of quantitative data may be taken in accordance with different methods:
the inventory is conducted based on plans or in situ, by taking the necessary readings in each of the rooms involved in so far as they are accessible,
an inventory is conducted by equipment ratio in respect of the so-called “generic” rooms. A certain number of rooms listed as being in radiation zone 1, 2, or 3, not able to be contaminated, may be considered as generic, in other words as rooms whose function is found in most nuclear buildings, such as corridor, staircase, airlock, etc.

It is then possible, as specified in the second step, to specify for each room the standard plant they contain and the associated ratios allowing the inventory thereof to be quantitatively estimated: equipment ratios calculated by general facility experts relative to the floor area of the premises or to the volume of the premises.

The ratios are categorized in three classes:
primary ratios independent of the agreed standard scenario and of the facility under consideration. These ratios allow for example the waste generated by the different tasks to be quantified,
scenario ratios dependent on the agreed standard scenario. These ratios are essentially relative to the clothing worn, hourly outputs,
the ratios dependent on the facility under consideration. These ratios are relative to operating charges, hourly rates, costs of plant and consumables, costs of treating waste and discharges, etc.

All these ratios are recorded in a database. The ratios are drawn up using feedback from remediation sites and maintenance operations on nuclear facilities.

Some ratio examples may be as follows:
vessel washing: 3 m³ of discharges per m³ of vessel
wall scraping: 3 hours/m²,
volume of discharge generated by high pressure jets: 0.08 m³ of discharge per m² treated.

In accordance with the second step, the tasks are associated with such ratios, which, when multiplied by the first data produced by the inventory, allow second data to be calculated such as: time in hours, discharge volumes, volumes and weight of waste, doses.

Assigning a task to a standard scenario is formalized through the existence of formulae for calculating said second data from which are then calculated the hours and quantities of waste related to this task. The tasks associated with each standard scenario are of different types.

The inventive method, in the second step, allows the following data to be evaluated: time in hours, quantities of discharge/waste, doses and costs generated by the operations to clean up/dismantle one or more nuclear facilities.

In accordance with the third step, determining the overall cost of cleaning up/dismantling the facility is based on evaluating the second primary data: cost of manpower, waste and discharges, etc., taking into consideration services provided in relation to manpower: linen, spinoff waste, consumables, etc., and general elements: operating costs, developments, etc.

FIG. 2 shows the rooms in a facility, in this case a building with a plurality of storeys to be dismantled with a choice of standard scenarios.

### Embodiment Example

In one embodiment example, consideration is given to the type 1 scenario, specified in Table I at the end of the specification, which corresponds to a High Dose Rate Cell of the Chemical type to be fitted by tele-operation, with the associated tasks marked, below, with a cross, the description of each task being given against the number thereof.

TABLE I

| Interventions on containment pool vessels/containment pools/ponds | | |
|---|---|---|
| 1 | Final draining by tele-operation | X |
| 2 | Final manual draining | X |
| 3 | Installing a sludge pumping station (containment pool) | |
| 4 | Installing access airlocks for divers (containment pools) | |
| 5 | Sludge pumping (containment pool bottom) by divers | |
| Excavations | | |
| 6 | Removal of earth (raceways) | |
| Radiation monitoring | | X |
| 7 | Number 1 radiation reading before tele-operation | X |
| 8 | Number 2 radiation reading before primary clean-up | X |
| 9 | Number 3 radiation reading before dismantling by contact | X |
| 10 | Number 4 final radiation reading | |
| Tele-operation and work under water | | |
| 11 | Preparing area for intervention by tele-operation | X |
| 12 | Withdrawal from area for intervention by tele-operation | X |
| 13 | Extracting remotely collapsible equipment and pipes and fittings other than those | X |
| | with very low level radiation | |
| 14 | Cutting out and extracting pipes and fittings by porthole view tele-operation | X |
| | other than those with very low level radiation | |
| 15 | Cutting out and extracting pipes and fittings by camera view tele-operation | X |
| | other than those with very low level radiation | |
| 16 | Cutting out and extracting equipment by porthole view tele- | X |
| | operation other than that with very low level radiation | |
| 17 | Cutting out and extracting equipment by camera view tele- | X |
| | operation other than that with very low level radiation | |
| 18 | Cutting out and extracting drip pans (metal holding tank covering | X |
| | the bottom of the cells) and coatings by porthole view tele-operation other | |
| | than those with very low level radiation | |
| 19 | Cutting out and extracting drip pans and coating by camera view | |
| | tele-operation other than those with very low level radiation | |
| 20 | Cutting out and extracting equipment and pipes and fittings other | X |
| | than those with very low level radiation under water (divers) | |
| 21 | Decontaminating walls by swabbing by tele-operation | X |
| 22 | Decontaminating walls and equipment by sandblasting + glazing by tele-operation | X |
| 23 | Decontaminating by Pu dust removal (which comprises recovering | X |
| | the plutonium dioxide (PuO2) which presents in solid form; | |
| | Relates mainly to glove boxes or dry process equipment in the | |
| | medium activity workshops) by tele-operation | |
| 24 | Decontaminating walls and equipment by carbon dioxide snow | X |
| | (liquid CO2 is expanded and is converted to carbonic snow; this | |
| | snow is then compressed and extruded to form ice pellets; These | |
| | pellets are sprayed at supersonic speed onto the medium to be treated) | |
| | by tele-operation | |
| 25 | Decontaminating walls and equipment by gel or foam by tele-operation | |
| External manual decontamination | | X |
| 26 | Decontaminating walls by damp swabbing | X |
| 27 | Decontaminating walls by dry swabbing | X |
| 28 | Decontaminating with high pressure jet + glazing walls and equipment | |
| 29 | | X |
| 30 | Scraping concrete walls and glazing | X |
| 31 | Scaling concrete walls and glazing | X |
| 32 | Sucking off and glazing walls and equipment - Pu dust removal | |
| 33 | Flushing walls and equipment | |
| 34 | | X |
| 35 | Sandblasting and glazing walls and equipment | X |
| 36 | Decontaminating walls and equipment by carbon dioxide snow | X |
| 37 | Decontaminating walls and equipment by gel or foam | X |
| 38 | Electrodecontamination of walls and equipment | |
| Manual interventions | | X |
| 39 | Preparing area for manual intervention | X |
| 40 | Withdrawing from area for manual intervention | X |
| 41 | | |
| 42 | | |
| 43 | Demolishing large volume concrete | X |
| 44 | Extracting biological shields made of lead brick | X |
| 45 | Cutting out and extracting biological shields made of lead (shielded | X |
| | enclosure, cover plates, etc.) | |
| 46 | Extracting biological shields made of barite | |
| 47 | Extracting Perspex | X |
| 48 | Cutting out and extracting hatches, doors, framework, shielding. | X |
| | Steel, cast iron other than those with very low level radiation | |
| 49 | Cutting out and extracting pipes and fittings and support + | X |
| | pneumatic transfer networks other than those with very low level | |
| | radiation | |
| 50 | Cutting out and extracting equipment other than that with very low | |
| | level radiation | |
| 51 | Cutting out and extracting solid equipment other than that with very low | X |
| | level radiation | |
| 52 | Cutting out or dismantling hatches, doors, framework, pipes and fittings and | X |
| | sheaths with very low level radiation | |
| 53 | Cutting out and extracting drip pans other than those with very low level | X |
| | radiation | |
| 54 | Cutting out and extracting coatings other than those with very low | |
| | level radiation | |
| 55 | Removing and cutting out small-sized glove boxes (<2 m³) other | |
| | than those with very low level radiation | |
| 56 | Cutting out on site and removing large-sized glove boxes (>2 m³) | X |
| | other than those with very low level radiation | |
| 57 | Cutting out and extracting relatively uncontaminated ventilation | X |
| | sleeves other than those with low level radiation | |
| 58 | Cutting out and extracting contaminated ventilation sleeves other | |
| | than those with low level radiation | |
| 59 | Cutting out and extracting solid equipment with very low level | X |
| | radiation | |
| 60 | Cutting out and extracting drip pans, coatings and enclosures with very low | X |
| | level radiation | |
| 61 | Extracting breezeblocks, plaster, wood and neutron/biological shielding | |
| 62 | | X |
| 63 | Extracting ventilation screws and sleeves | X |
| 64 | | X |
| 65 | Extracting cross ducts, pipes and fittings and sheaths | X |
| 66 | Cutting out fire bricks | X |
| 67 | Cutting out and extracting asbestos | |
| 68 | | X |
| 69 | Draining oil | X |
| 70 | Extracting portholes (glass) | X |
| 71 | Internal decontamination of vessels | |

### Description of Standard Scenarios

1. Scenario of a “High Dose Rate (HDR) Cell to be Fitted with Tele-Operation Means (Zone 4)”

This is a cell where asbestos prevails thereby preventing an operator from entering. It is therefore necessary to extract the most radioactive equipment by tele-operation before the intervention by contact. The cell, often of the “chemical process” type, is not equipped at the outset with the means to intervene by tele-operation.

2. Scenario of a “High Dose Rate (HDR) Cell Fitted with Tele-Operation Means (Zone 4)”

This is a cell where asbestos prevails thereby preventing an operator from entering. The cell, often of the “mechanical” type, is already fitted with operation viewing and intervention means. In particular, it is, generally speaking, equipped with a bridge, an adjacent intervention cell which can be accessed by contact or a bridge garage and a large-scale waste airlock so that the equipment can be removed.

3. Scenario of a “Medium Dose Rate (MDR) Cell (Zone 4)”

This is a cell, generally of the “chemical” type, where strong activity prevails and where a long internal decontamination of the equipment allows the activity to be reduced to the point where cell penetration is possible for an intervention by contact.

4. Scenario of a “Low Dose Rate (LDR) Cell with Low Alpha Risk (Zone 4)”

This is a cell of the “chemical” or “mechanical” type allowing an intervention by contact.

5. Scenario of a “Low Dose Rate (LDR) Cell with High Alpha Risk (Zone 4)”

This scenario is equivalent to scenario number 4, except that the risk generated by the alpha or tritium contamination compels the use of ventilated clothing instead and in place of mask clothing for most of the dismantling operations.

6. Scenario of a “Containment Pool or Pond with Sludge or Heavy Radioactive Deposit on the Bottom (Apart from Reactor Containment Pool) (Zone 4)”

These are cells filled with water that may contain deposits on the bottom. A distinction may be made between:
containment pools which are concrete structures coated in stainless steel,
ponds which are concrete structures with no metal coating.

The dismantling operations assume that the containment pools or ponds are empty of fuels, plant or radioactive materials discarded during operations.

7. Scenario of a “Containment Pool or Pond with No Sludge and with a Small Radioactive Deposit on the Bottom (Zone 4)”

These are cells filled with water with no deposit on the bottom. A distinction may be made between:
containment pools which are concrete structures coated in stainless steel,
ponds which are concrete structures with no metal coating.

8. Scenario of a “High Dose Rate (HDR) Internal Raceway (Zone 4)”

This scenario is equivalent to scenario number 1 but taking into consideration a cell of reduced dimensions (height or width <2 m). The raceways always have on the ceiling (exceptionally on the side) concrete, lead or steel cover plates which may be deposited and left in situ.

9. Scenario of a “Medium Dose Rate (MDR) Internal Raceway (Zone 4)”

This scenario is equivalent to scenario number 3 but taking into consideration a cell of reduced dimensions (height or width <2 m).

10. Scenario of a “Low Dose Rate (LDR) Internal Raceway (Zone 4)”

This scenario is equivalent to scenario number 4 but taking into consideration a cell of reduced dimensions (height or width <2 m).

11. Scenario of a “High Dose Rate (HDR) External Raceway (Zone 4)”

The raceways are concrete structures with stainless steel cases enclosed by a cover plate at their upper part. They convey products that have a level of activity above 2.5 Ci/m³ (curies per m³).

When two cavities of a single raceway are next to each other, each one is treated according to its type but from the same airlock.

When two cavities of different categories are located one above the other, they are treated in accordance with the type of the most active cavity since the irradiation from the latter prevents manual work from being carried out in the inactive cavity.

This scenario is equivalent to scenario number 1 but taking into consideration a cell of reduced dimensions (height or width <2 m).

12. Scenario of a “Low Dose Rate (LDR) External Raceway (Zone 4)”

The raceways are concrete structures enclosed by a cover plate at their upper part. They convey products that have a level of activity below 2.5 Ci/m³. This scenario is equivalent to scenario number 4 but taking into consideration a cell of reduced dimension (height or width <2 m).

13. Scenario of a “Waste Stack (Zone 3)”

This is a very high structure and one that is difficult to access, made of concrete or steel or steel-coated concrete or lined concrete.

14. Scenario of a “Shielded Enclosure (Zone 4)”

Shielded enclosures are metal units containing analysis chains, experimentation chains, sample taking benches. They convey active (radiation emitting and/or contaminating) products. They are equipped with viewing portholes and fitted with tongs or remote manipulators. They may contain capacities which are washed and decontaminated internally like the capacities of the HDR or MDR cells. In general, they are found in rooms equipped with a bridge allowing the shields of the enclosure to be manipulated. Concrete-framed shielded enclosures are considered as dismantled cells in accordance with the standard scenarios numbers 1 to 5.

15. Scenario of an “Unshielded Enclosure (Zone 4)”

Unshielded enclosures are metal units containing products which need to be confined but which do not give off high dose radiation. They are commonly known as “glove boxes”. They are generally small in size and come in a single case. They may contain capacities which are washed and decontaminated internally like the capacities of LDR cells.

16. Scenario of a “Laboratory or Room Containing an Enclosure (Zone 3)”

These are operations rooms or laboratories containing enclosures or glove boxes.

17. Scenarios of a “Zone 3 “Clean” or “Normal” cell (zone 3)”

These are intervention cells of every sort: transmitter rooms, ventilation filter rooms, rooms for the production of a vacuum, vacuum filters and vacuum breaker valves, utilities distribution rooms, reagent distribution rooms, airlocks, bridge garages, ventilation flues. By way of information, the criteria for categorizing a zone 3 cell as scenario 13 “clean” are:
the radiation (produced by contamination) is below 7.6 μSv/h (micro Sieverts per hour),
moving around in white clothing,
no operating malfunction with residual consequences.

18. Scenario of a “Containment Pool, Pond, Storage, Reactor Hall Etc. (Zone 3)”

These are large-sized operations rooms located above the containment pools, ponds and reactors.

19. Scenario of a “Cell that is Relatively Uncontaminated or Uncontaminated (Zone 1/Zone 2)”

These are relatively uncontaminated or uncontaminated rooms of every sort.

### Table II

### Description of Tasks

Interventions on containment pool vessels/containment pools/ponds
1 Final draining by tele-operation
2 Final manual draining
3 Installing a sludge pumping station (containment pool)
4 Installing access airlock divers (containment pools)
5 Sludge pumping (bottom of containment pools) by divers

### Excavations

6 Removal of earth (access to raceways)

### Radiation Monitoring

7 Number 1 radiation reading before tele-operation
8 Number 2 radiation reading before primary clean-up
9 Number 3 radiation reading before dismantling by contact
10 Number 4 final radiation reading

### Tele-Operation and Work Under Water

11 Preparing area for intervention by tele-operation
12 Withdrawing from area for intervention by tele-operation
13 Extracting remotely collapsible equipment and pipes and fittings whether or not under water other than those with very low level radiation
14 Cutting out and extracting pipes and fittings by porthole view tele-operation other than those with very low level radiation
15 Cutting out and extracting pipes and fittings by camera view tele-operation other than those with very low level radiation
16 Cutting out and extracting equipment by porthole view tele-operation other than that with very low level radiation
17 Cutting out and extracting equipment by camera view tele-operation other than that with very low level radiation
18 Cutting out and extracting drip pans and coatings by porthole view tele-operation other than those with very low level radiation
19 Cutting out and extracting drip pans by camera view tele-operation other than those with very low level radiation
20 Cutting out and extracting equipment and pipes and fittings under water (divers) other than those with very low level radiation
21 Decontaminating walls by swabbing by tele-operation
22 Decontaminating walls by sandblasting +glazing by tele-operation
23 Decontaminating walls by Pu dust removal by tele-operation
24 Decontaminating walls and equipment by carbon dioxide snow by tele-operation
25 Decontamination walls by gel by tele-operation

### External Manual Decontamination

26 Decontaminating walls by damp swabbing
27 Decontaminating walls by dry swabbing
28 Decontaminating by high pressure jet +glazing of walls and equipment
29
30 Scraping concrete walls and glazing
31 Scaling concrete walls and glazing
32 Sucking off and glazing walls and equipment—Pu dust removal
33 Flushing walls and equipment
34
35 Sandblasting and glazing walls and equipment
36 Decontaminating walls and equipment by carbon dioxide snow
37 Decontaminating walls and equipment by gel or foam
38 Electrodecontamination of walls and equipment

### Manual Interventions

39 Preparing area for manual intervention
40 Withdrawing from area for manual intervention
41
42
43 Demolishing large volume concrete
44 Extracting biological shields made of lead bricks
45 Cutting out and extracting biological shields made from lead (shielded enclosure, cover plates, etc.,)
46 Extracting biological shields made from barite
47 Extracting Perspex
48 Cutting out and extracting hatches, doors, framework, shielding. Steel, cast iron other than those with very low level radiation
49 Cutting out and extracting pipes and fittings and support +pneumatic transfer networks (pipes used to pass either pitchers (small polymer bottles) filled with liquid samples for laboratory analyses or shuttles carrying solid samples of plutonium dioxide for analyses) other than those with very low level radiation
50 Cutting out and extracting equipment other than that with very low level radiation
51 Cutting out and extracting solid equipment other than that with very low level radiation
52 Dismantling and extracting hatches, doors, framework, pipes and fittings and sheaths with very low level radiation
53 Cutting out and extracting drip pans other than those with very low level radiation
54 Cutting out and extracting coatings other than those with very low level radiation
55 Cutting out and removing small-sized glove boxes (<2 m³) other than those with very low level radiation
56 Cutting out on site and removing large-sized glove boxes (>2 m³) other than those with very low level radiation
57 Cutting out and extracting relatively uncontaminated ventilation sleeves other than those with very low level radiation
58 Cutting out and extracting contaminated ventilation sleeves other than those with very low level radiation
59 Cutting out and extracting solid equipment with very low level radiation
60 Cutting out and extracting drip pans, coatings and enclosures with very low level radiation
61 Extracting breezeblocks, plaster, wood and neutron/biological shielding
62
63 Extracting ventilation screws and sleeves
64
65 Extracting cross ducts, pipes and fittings and sheaths
66 Cutting out fire bricks
67 Cutting out and extracting asbestos
68
69 Removing oil
70 Extracting portholes (glass)
71 Internal decontamination of vessels

Tasks 29, 34, 41, 42, 62, 64, 68 do not so far exist. The cells in the table are free to receive new tasks in the future (e.g. of the laser decontamination or laser cutting type).

1. Method for dismantling a nuclear facility comprising at least one room, itself comprising equipment and structures, said method including a plurality of dismantling steps and a step of evaluating technical clean-up/dismantling data, wherein this evaluation step implements:
a first table listing clean-up/dismantling tasks,
a second table in which each standard cell of a set of standard cells, bringing into play at least one task of the first table, is assigned to a given room in the facility to be cleaned up/dismantled,
a database containing ratios corresponding to the tasks,
and wherein this evaluation step includes a step of multiplying the ratios corresponding to the tasks of the standard cell assigned to each room in the facility by first data, which are dimensional data, quantitative data or contamination states of the equipment and structures in this room, so as to obtain second technical data chosen from among: time in hours, quantities of discharge/waste and doses.

2. Method as claimed in claim 1, wherein the ratios are categorized in three classes:
primary ratios independent of the agreed standard scenario (or standard cell) and of the facility under consideration,
scenario ratios dependent on the agreed standard scenarios,
ratios dependent on the facility under consideration.
